(19) United States
(12) Patent Application Publication
(10) Pub. No.: US 2005/0157333 A1
(43) Pub. Date: Jul. 21, 2005

(54) Printing apparatus and method of outputting wireless network searching results

(75) Inventors: Jae-Kyung Cho, Suwon-si (KR); Jin-Hyung Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/035,273

(22) Filed: Jan. 14, 2005

(30) Foreign Application Priority Data
Jan. 17, 2004 (KR) 2004-3579

(51) Int. Cl. G06F 15/00

(52) U.S. Cl. 358/1.15

(57) ABSTRACT

An apparatus and method for outputting a result of a wireless network search are provided. The apparatus and method include outputting the wireless configuration state of a printing apparatus which transceives data with at least one peripheral wireless network apparatus connected thereto through wireless network. The apparatus and method further include receiving a search request of the wireless configuration state of the printing apparatus and the wireless configuration state of the wireless network apparatus from the user, searching the wireless configuration state of the printing apparatus and the searched wireless configuration state of the wireless network apparatus according to the request of the user, and outputting the results of the searched wireless configuration state of the printing apparatus and the wireless configuration state of the wireless network apparatus.

### PRIORITY

This application claims the benefit under 35 U.S.C. 119(a) of Korean Patent Application No. 2004-3579, filed on Jan. 17, 2004, in the Korean Intellectual Property Office, the entire disclosure of which is incorporated by reference.

### BACKGROUND OF THE INVENTION

1. Field of the Invention

The present invention relates to a wireless printing apparatus and method. More particularly, the present invention relates to an apparatus and method of outputting a result of a wireless network search, which outputs a wireless configuration state of a wireless network apparatus by searching a peripheral wireless network apparatus of a printing apparatus that prints wirelessly received data.

2. Description of the Related Art

A computer can perform printing by transmitting data to a printing apparatus such as a printer. U.S. Pat. No. 6,493,104, which is incorporated herein by reference, discloses a computer having a wireless connection to a printer.

A printing apparatus includes a wireless network module or wireless network card as shown in FIG. 1 and transceives data wirelessly through a peripheral network apparatus such as a computer. FIG. 1 is a block diagram illustrating a wireless network module 100.

As shown in FIG. 1, the wireless network module 100 includes a central processing unit (CPU) 110, a read only memory (ROM) 112, a random access memory (RAM) 114, a non-volatile random access memory (NV RAM) 116, an input and output interface unit 118, and a wireless communication module 120. The CPU 110 controls the entire wireless network module 100 and the memories 112, 114, and 116 store data. The input and output interface unit 118 transceives data with external peripheral devices, and the wireless communication module 120 communicates with wireless network devices through the wireless network 130.

In general, an operation mode is configured for the printing apparatus to communicate with the wireless network device. Different operation modes include an ad-hoc mode and an infrastructure mode. FIG. 2 is a diagram illustrating the structure of a wireless ad-hoc mode and FIG. 3 is a diagram illustrating wireless structure of the infrastructure mode.

As illustrated in FIG. 2, the printing apparatus 10, which is configured in the ad-hoc mode, can be directly connected to peripheral wireless network devices, for example, a laptop computer 22 or a computer 24. As illustrated in FIG. 3, the printing apparatus 10 configured in the infrastructure mode can be connected to a wireless network device, for example, a laptop computer 38, through an access point 30. The printing apparatus 10 may also be connected to computer 32, 34 and 36 through the access point 30 by wire.

In addition, for the printing apparatus to communicate with the wireless network device, the printing apparatus should configure the values of a service set identifier (SSID), a channel and a wired equivalent privacy (WEP) standard etc. FIG. 4 illustrates an output result of the wirelessly configured state which is configured in the printing apparatus after configuring such values. Specifically, FIG. 4 is a diagram illustrating the output result for a wireless configuration state of the printing apparatus.

As illustrated in FIG. 4, the operation mode of the printing apparatus is an infrastructure mode, SSID is Samsung, and the channel is 7. A WEP Authentication uses an open system and the coding uses a 64 bit key. The current connection state indicates that the printing apparatus is connected.

As described above, to input the wireless configuration contents in the conventional printing apparatus, the user should have information on the network that the user is going to configure. As illustrated in FIG. 4, since the result of the wireless configuration of the printing apparatus only indicates the basic wireless configuration state of the printing apparatus it does not help the user when inputting the wireless configuration contents.

### SUMMARY OF THE INVENTION

Accordingly, the embodiments of the present invention have been made to solve the above-mentioned problems occurring in the prior art and to provide other advantages. An object of the present invention provides a method of searching and outputting a wireless configuration state of a peripheral wireless network apparatus connected to a printing apparatus printing wirelessly received data.

Embodiments of the present invention also provide a printing apparatus for printing wirelessly received data and searching and outputting a wireless configuration state of a peripheral wireless network apparatus connected thereto.

According to an aspect of the present invention, there is provided a method of outputting a wireless configuration state from a printing apparatus which sends data to and receives data from at least one peripheral wireless network device of the printing apparatus through a wireless network. The method comprises receiving a search request from a user for a wireless configuration state of the printing apparatus and a wireless configuration state of the wireless network device; searching the wireless configuration state of the printing apparatus and the wireless configuration state of the wireless network device in response to the request of the user; and outputting a result of the searched wireless configuration state of the printing apparatus and the searched wireless configuration state of the wireless network device.

Outputting the result of the searched wireless configuration state may comprise comparing the wireless configuration state of the printing apparatus to the wireless configuration state of the wireless network device; and arranging the wireless configuration state result of the wireless network device according to the result of the comparison.

According to another aspect of the present invention, there is provided a printing apparatus, which transceives data with at least one of a peripheral wireless network device of the printing apparatus through a wireless network. The apparatus comprises a receiving unit, which receives a search request for a wireless configuration state of the printing apparatus and a wireless configuration state of the wireless network device from the user; a search unit, which searches the wireless configuration state of the printing apparatus and the wireless configuration state of the wireless network device in response to the request of the user; and an output unit, which outputs a result of the searched wireless configuration state of the printing apparatus and the wireless configuration state of the wireless network device.

The outputting unit may comprise a comparing unit, which compares the wireless configuration state of the printing apparatus to the wireless configuration state of the wireless network device; and an arranging unit, which arranges the wireless configuration state result of the wireless network device according to the comparison result.

### BRIEF DESCRIPTION OF THE DRAWINGS

The above and other features and advantages of the present invention will become more apparent by describing in detail exemplary embodiments thereof with reference to the accompanying drawings in which:

FIG. 1 is a block diagram of a conventional wireless network module;

FIG. 2 is a diagram illustrating the structure of a conventional ad-hoc mode;

FIG. 3 is a diagram illustrating the structure of an infrastructure mode;

FIG. 4 is a diagram illustrating a result of a conventional output of a wireless configuration state of a printing apparatus;

FIG. 5 is a block diagram illustrating a printing apparatus according to an embodiment of the present invention;

FIG. 6 is a flow chart illustrating a method of outputting a result of the wireless network search according to an embodiment of the present invention;

FIG. 7 is a flow chart describing in detail the operations of outputting the search result of FIG. 6;

FIG. 8 is a flow chart illustrating a method for performing a configuration according to a result of a comparison;

FIG. 9 is a diagram illustrating a result of the output of the wireless configuration state according to an embodiment of the present invention; and

FIG. 10 is a diagram illustrating a result of the output of the wireless configuration state according to the present invention.

Throughout the drawings, it should be noted that like reference numbers are used to depict the same or similar elements, features and structures are denoted by like reference numerals.

### DETAILED DESCRIPTION OF EXEMPLARY EMBODIMENTS

FIG. 5 is a block diagram illustrating a printing apparatus according to an embodiment of the present invention.

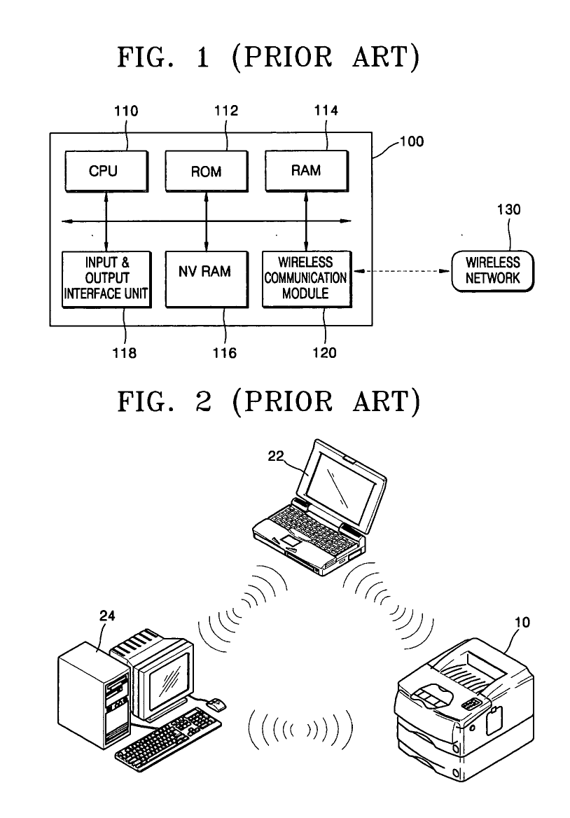

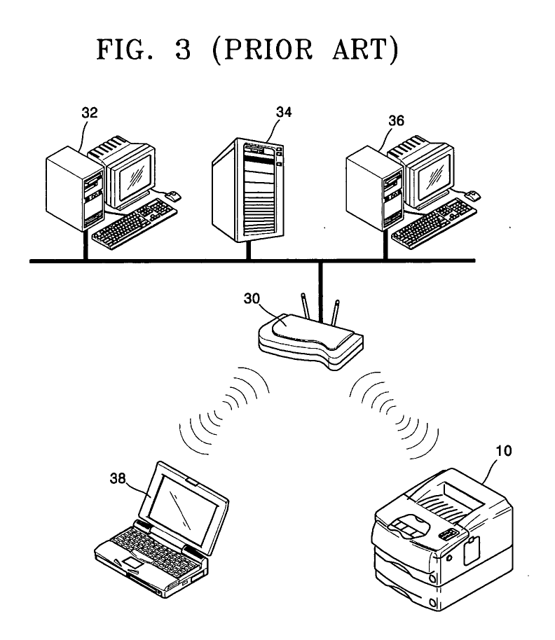

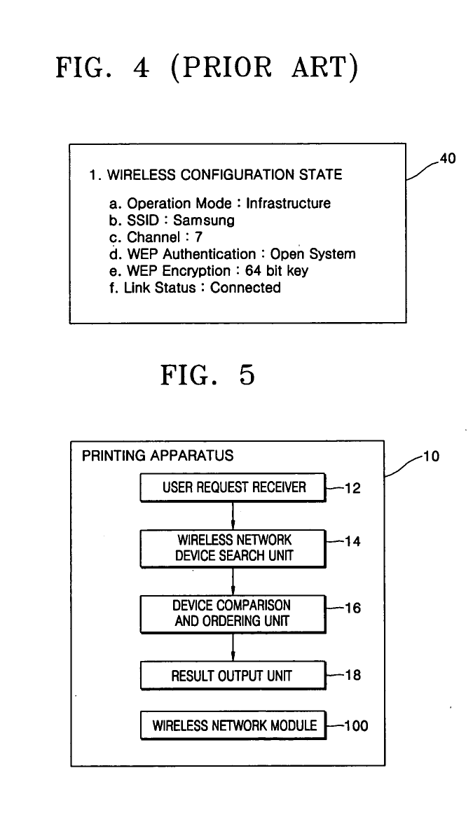

As illustrated, a printing apparatus 10 includes a user request receiver 12, a wireless network device searcher 14, a device comparison and arranging unit 16, a result outputting unit 18, and a wireless network module 100. The printing apparatus 10 transceives data with at least one of a peripheral wireless network device through a wireless network by using the wireless network module 100 as illustrated in FIG. 1.

The user request receiver 12 receives requests from a user to search for a wireless configuration state of the printing apparatus 10 and a wireless configuration state of the wireless network device, and the wireless network device searcher 14 searches for the wireless configuration state of the printing apparatus 10 and the wireless configuration state of the wireless network device according to the user's request.

The device comparison and arranging unit 16 compares the wireless configuration state of the printing apparatus with the wireless configuration state of the wireless network device and arranges the result of the wireless configuration state of the wireless network device according to the result of the comparison. To be more specific, the device comparison and arranging unit 16 categorizes the wireless network device as a network device which can be connected to when the wireless configuration state of the printing apparatus and the wireless configuration state of the wireless network device are the same. Meanwhile, the device comparison and arranging unit 16 categorizes the wireless network device as a network device which can be connected to after changing the configuration of the wireless network device when the wireless configuration state of the printing apparatus and the wireless configuration state of the wireless network device are different and provides configuration change contents needed to enable the connection of the printing apparatus to the wireless network device.

The result output unit 18 outputs the result of the wireless configuration state of the searched printing apparatus and the wireless configuration state of the wireless network device. Preferably, the result output unit 18 outputs the result on paper. The result can be output in response to a user's request to output the result and the result can be output on a display unit such as the liquid crystal display (LCD) and the like which is included in the printing apparatus. However, when the LCD is not large enough to output the result or when there is no LCD, by outputting the result on paper the user may conveniently confirm the result.

The wireless configuration state includes at least one of an operation mode, a service set identifier (SSID), a channel, and a wired equivalent privacy (WEP), and the operation mode includes an infrastructure mode and an ad-hoc mode. The wireless network device may include a station and an access point.

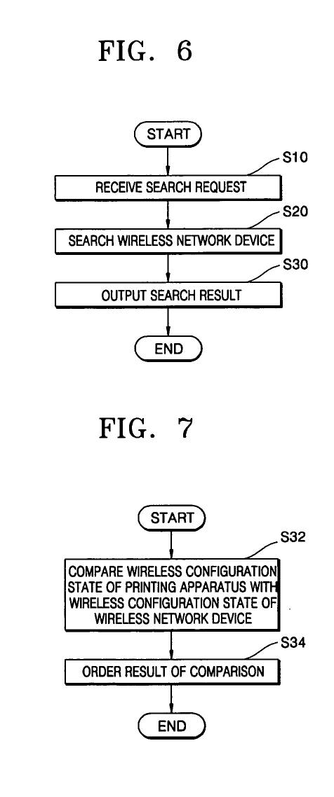

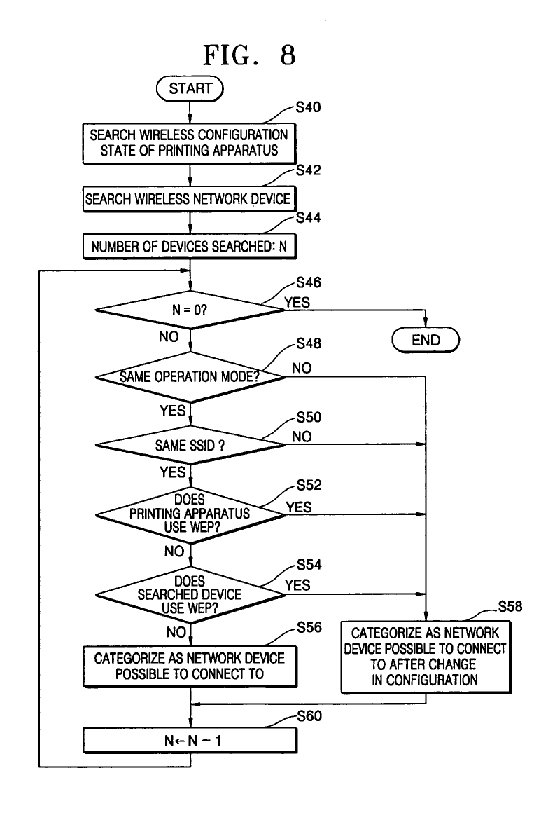

A method for outputting the result of the wireless network search according to the present invention will be described with reference to FIGS. 6, 7, and 8. FIG. 6 is a flow chart illustrating a method of outputting the result of the wireless network search according to an embodiment of the present invention, FIG. 7 is a flow chart illustrating in more detail the stages of the output of the search result, and FIG. 8 is a flow chart illustrating categorization according to the result of comparison.

As illustrated in FIG. 6, in operation S10, the request to search the wireless configuration state of the printing apparatus and the wireless configuration state of the wireless network device are received from the user. The user can request a search using an operation panel equipment (OPE) of the printing apparatus. Next, the wireless configuration state of the printing apparatus and the wireless configuration state of the wireless network device is searched in response to the user's request S20. The search may be performed using a wireless communication module that follows an IEEE 802.11 standard. The IEEE 802.11 standard is a standard for wireless communication in computers, laptop computers, and personal digital assistants (PDA). The result of the search of the wireless configuration state of the printing apparatus and the wireless configuration state of the wireless network device are output S30. Preferably, the result is printed on paper by a printer. In addition, the result may be output on a display unit, for example, an LCD of a printer.

As illustrated in FIG. 7, the wireless configuration state of the printing apparatus is compared with the wireless configuration state of the wireless network device S32, and according to the result of comparison the result of the wireless configuration state of the wireless network device is arranged S34.

In the above arrangement, the wireless network device is categorized as a network device that can be connected to when the wireless configuration state of the printing apparatus and the wireless configuration state of the wireless network device are the same. Meanwhile, the wireless network device is categorized as a network device that is possible to be connected to after changing the configuration when the wireless configuration state of the printing apparatus and the wireless configuration state of the wireless network device are different, and the configuration change contents needed in enabling the printing apparatus to connect to the wireless network device are provided. A method of categorization according to the above-described result of comparison will be described with reference to FIG. 8.

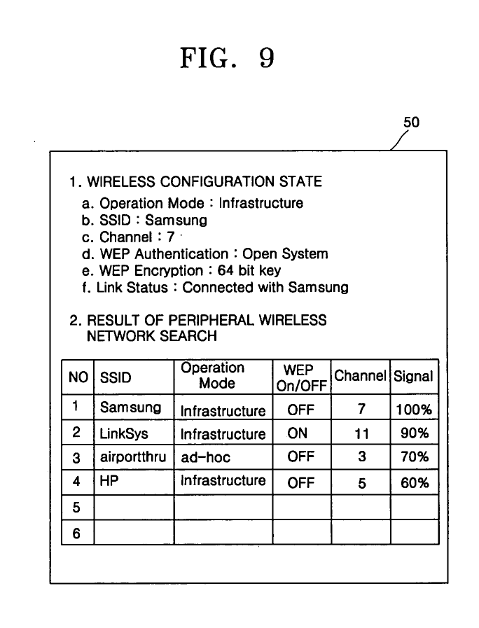

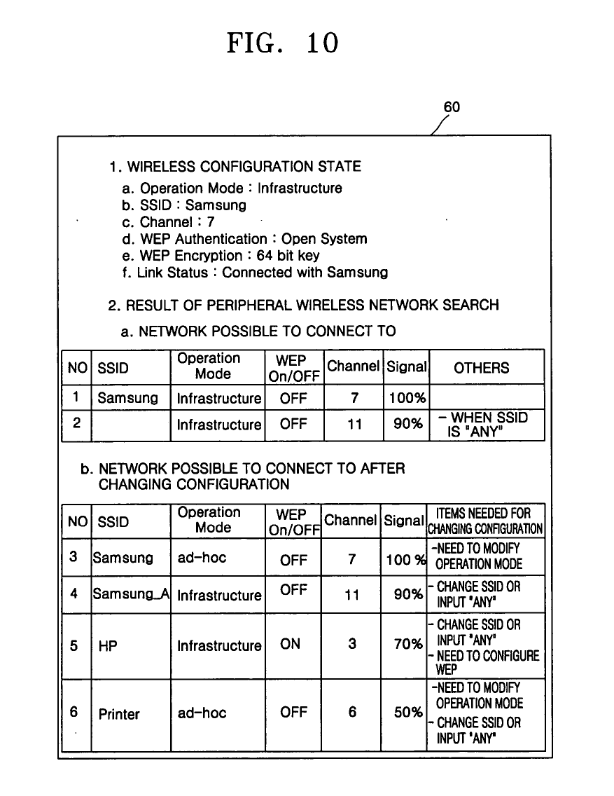

As illustrated in FIG. 8, the wireless configuration state of the printing apparatus is searched S40. The searched wireless configuration state includes an operation mode, a service set identifier (SSID), and a wired equivalent privacy (WEP) protocol as illustrated in FIGS. 9 and 10. The WEP protocol is an algorithm for providing privacy for the wired LAN. The infrastructure mode and the ad-hoc mode can be configured as the operation mode. When the printing apparatus is in the infrastructure mode it can be connected to other network devices through the access point. Meanwhile, when the printing apparatus is in the ad-hoc mode it can be directly connected to peripheral wireless network devices, for example, a laptop computer or a computer.

Next, the wireless network device or wireless network station is searched in operation S42. The wireless network station is a wireless network device such as a wireless computer, a PDA etc., or an access point. However, in the description that will follow it is assumed that the wireless network device includes a wireless network station. In operation S44, when the number of searched wireless network devices is N, it is determined in operation S46 whether N is 0. When N is 0 it is assumed that the search network device does not exist and the process is terminated.

When N is not 0, the wireless configuration state of the printing apparatus and the wireless configuration state of the searched wireless network device are determined. It is determined in operation S48 whether the operation modes are identical. When the operation modes are not identical, the searched wireless network device is categorized as a network device that can be connected to after changing configuration in operation S58. In stage S48, when the operation modes are identical, it is determined whether SSIDs are identical in operation S50. When the SSIDs are not the same, operation S58 is performed and the searched wireless network device is categorized as a network device that can be connected to after changing configuration. In operation S50, when the SSIDs are the same, it is determined whether the printing apparatus uses a WEP S52. When the printing apparatus uses a WEP, operation S58 is performed and the searched wireless network device is categorized as a network device that can be connected to after changing configurations. In operation S52, when the printing apparatus does not use a WEP, it is determined whether the searched wireless network device uses a WEP S54. When the searched wireless network device uses a WEP, operation S58 is performed and the searched wireless network device is categorized as a network device that can be connected to after changing configuration. In operation S54, when the searched wireless network device does not use a WEP, the searched wireless network device is categorized as a network device that can be connected to after changing configuration. When the searched wireless network device does not use a WEP in operation 54, the searched wireless network device is categorized as a network device that can be connected to in operation S56. In operation S60, after operation S56 and S58 and after N decreases by 1, S46 is performed and the above process is repeated until all the searched wireless network devices are categorized as a network device that can be connected to or a network device that can be connected to after changing configurations.

As described above, when the wireless configuration state of the printing apparatus, i.e., the operation mode, the SSID and the WEP configuration, is the same as the wireless configuration state of the searched wireless network device, the searched wireless network device is categorized as a network device that can be connected to.

Referring to FIGS. 9 and 10, an example of a result of a wireless configuration state output according to an embodiment of the present invention will now be described. FIG. 9 illustrates an embodiment of a result 50 of the wireless configuration state output according to an embodiment of the present invention and FIG. 10 illustrates another example of a result 60 of the wireless configuration state output 60 according to an embodiment of the present invention.

FIG. 9 illustrates a state in which the searched result is not processed in any special way. Referring to FIG. 9, the wireless configuration state of the printing apparatus is indicated. The operation mode of the printing apparatus is an infrastructure mode, SSID is represented by Samsung, and the channel is 7. The WEP authentication uses an open system and coding uses a 64 bit key. The current connection state indicates that the printing apparatus is connected to a wireless network device with Samsung as the SSID.

Next, the search result of the peripheral wireless network device is disclosed. The searched wireless network devices are arranged in the order of a signal sensitivity level. The SSID of device number 1 is Samsung, the operation mode is an infrastructure mode, the WEP is not used, the channel is 7, and the signal sensitivity level is 100%. Next, the SSID of device number 2 is LinkSys, the operation mode is an infrastructure mode, the WEP is used, the channel is 11, and the signal sensitivity level is 90%. Since WEP is used for the printing apparatus to connect to LinkSys, a corresponding WEP configuration must be performed. For example, a 64-bit key used in WEP encrypting should be input.

Referring to FIG. 10, another example of the output result of a wireless configuration state will be described. FIG. 10 illustrates the result of categorizing the searched wireless network device as a network device that can be connected to or a network device that can be connected to after changing configurations.

Referring to FIG. 10, first of all, the wireless configuration state of the printing apparatus is indicated. The wireless configuration state is the same as that of what is illustrated in FIG. 9.

Next, the search result of peripheral wireless network device is indicated. A network that can be connected to is indicated. Stations that are included in the indication are networks that can be connected to in the current configuration state without changing the configuration.

The SSID of number 1 is Samsung, the operation mode is infrastructure, the WEP is not used, the channel is 7, and the signal sensitivity level is 100%. Next, the SSID of number 2 is “ANY”, that is, it has the value of null, which is when nothing is input. When the SSID does not have any value, regardless of the configured SSID, connection is possible. Therefore, in the two cases described above, the printing apparatus can be connected to the wireless network device without changing configuration.

Next, network devices that can be connected to after a change in configuration are indicated. Since the operation mode of number 3 is an ad-hoc mode, to connect to the number 3 device the operation mode should be changed to an ad-hoc mode. The SSID of number 4 is Samsung_A, and the SSID of the printing apparatus should be changed to Samsung_A or “ANY” should be input to connect to the number 4 device. Since the SSID of number 5 is HP and the WEP is configured, to connect to the number 5 device the SSID should be changed or “ANY” should be input and WEP should be configured. Since the SSID of number 6 is a Printer and the operation mode is ad-hoc to connect to the number 6 device the SSID should be changed or “ANY” should be input and the operation mode should be changed to ad-hoc.

As described above, in the result of the wireless configuration state output, the difference between the wireless configuration state of the printing apparatus and the wireless configuration state of the searched wireless network device is searched and the configuration change items that are needed for the printing apparatus to connect to the wireless network device are indicated.

As described above, when using the present invention, since the peripheral wireless network device of the printing apparatus is searched and the wireless configuration state of the wireless network device is output a user may perform a wireless configuration of the printing apparatus referring to the wireless configuration state of the wireless network device.

In addition, since the wireless configuration state of the printing apparatus is compared with the wireless configuration state of the searched wireless network device and the rearranged result is output, it is simple to determine which wireless configuration the printing apparatus should be changed to in order to connect the printing apparatus to the wireless network device.

While the present invention has been particularly shown and described with reference to exemplary embodiments thereof, it should be understood by those of ordinary skill in the art that various changes in form and details may be made therein without departing from the spirit and scope of the present invention as defined by the following claims.

1. A method of outputting a wireless configuration state from a printing apparatus which sends data to and receives data from at least one peripheral wireless network device of the printing apparatus through a wireless network, the method comprising:
receiving a search request from a user for a wireless configuration state of the printing apparatus and a wireless configuration state of the wireless network device;
searching the wireless configuration state of the printing apparatus and the wireless configuration state of the wireless network device in response to the request of the user; and
outputting a result of the searched wireless configuration state of the printing apparatus and the searched wireless configuration state of the wireless network device.

2. The method of claim 1, wherein the outputting of the result of the searched wireless configuration state comprises:
comparing the wireless configuration state of the printing apparatus to the wireless configuration state of the wireless network device; and
arranging the wireless configuration state result of the wireless network device according to the result of the comparison.

3. The method of claim 2, wherein the arranging of the wireless configuration state result comprises categorizing the wireless network device as a network device that can be connected to when the wireless configuration state of the printing apparatus and the wireless configuration state of the wireless network device are the same.

4. The method of claim 2, wherein the arranging of the wireless configuration state result comprises:
categorizing the wireless network device as a network device that is possible to connect to after changing configurations when the wireless configuration state of the printing apparatus and the wireless configuration state of the wireless network device are different; and
providing configuration change contents needed when connecting the printing apparatus to the wireless network device.

5. The method of claim 1, wherein the wireless configuration state comprises at least one of an operation mode, a service set identifier (SSID), a channel, and a wired equivalent privacy (WEP).

6. The method of claim 5, wherein the operation mode comprises at least one of an infrastructure mode and an ad-hoc mode.

7. The method of claim 1, wherein the wireless network device comprises an access point.

8. The method of claim 1, wherein the outputting of the result of the searched wireless configuration state comprises outputting the result on a paper.

9. A printing apparatus, which transceives data with at least one of a peripheral wireless network device of the printing apparatus through a wireless network, the apparatus comprising:
a receiving unit, which receives a search request for a wireless configuration state of the printing apparatus and a wireless configuration state of the wireless network device from the user;
a search unit, which searches the wireless configuration state of the printing apparatus and the wireless configuration state of the wireless network device in response to the request of the user; and
an output unit, which outputs a result of the searched wireless configuration state of the printing apparatus and the wireless configuration state of the wireless network device.

10. The printing apparatus of claim 9, wherein the outputting unit comprises:
a comparing unit, which compares the wireless configuration state of the printing apparatus to the wireless configuration state of the wireless network device; and
an arranging unit, which arranges the wireless configuration state result of the wireless network device according to the comparison result.

11. The printing apparatus of claim 10, wherein the arranging unit categorizes the wireless network device as a network device that can be connected to when the wireless configuration state of the printing apparatus and the wireless configuration state of the wireless network device are the same.

12. The printing apparatus of claim 10, wherein the arranging unit categorizes the wireless network device as a network device that is possible to be connected to after changing the configuration when the wireless configuration state of the printing apparatus and the wireless configuration state of the wireless network device are different, and provides configuration change contents needed to connect the printing apparatus to the wireless network device.

13. The printing apparatus of claim 9, wherein the wireless configuration state comprises at least one of an operation mode, a service set identifier (SSID), a channel, and a wired equivalent privacy (WEP).

14. The printing apparatus of claim 10, wherein the operation mode comprises at least one of an infrastructure mode and an ad-hoc mode.

15. The printing apparatus of claim 9, wherein the wireless network device comprises an access point.

16. The printing apparatus of claim 9, wherein the outputting unit comprises a unit outputting the result on paper.
